(19) United States
(12) Patent Application Publication
(10) Pub. No.: US 2019/0158820 A1
(43) Pub. Date: May 23, 2019

(54) STEREOSCOPIC VIDEO DISPLAY DEVICE AND STEREOSCOPIC VIDEO DISPLAY METHOD

(71) Applicant: HON HAI PRECISION INDUSTRY CO., LTD., New Taipei (TW)

(72) Inventors: HSUEH-WEN LEE, New Taipei (TW); CHI-HSUN HO, New Taipei (TW); HUI-WEN WANG, New Taipei (TW); YI-TE HSIN, New Taipei (TW); CHUN-YEN KUO, New Taipei (TW)

(21) Appl. No.: 15/835,406

(22) Filed: Dec. 7, 2017

(30) Foreign Application Priority Data
Nov. 21, 2017 (CN) 201711166792.X

(51) Int. Cl. H04N 13/398; H04N 21/4223; H04N 21/485; H04N 13/189; G06K 7/14; H04N 13/194; G06K 7/10

(52) U.S. Cl. CPC H04N 13/398; H04N 21/4223; H04N 21/485; G06K 7/10722; G06K 7/1417; H04N 13/194; H04N 13/189

(57) ABSTRACT

A stereoscopic video display method includes steps of receiving a video display operation for displaying a stereoscopic video, the QR code for which being input through an input unit. The stereoscopic video is displayed on a display screen in response to the video display operation.

### FIELD

The subject matter relates to image display technology, and more particularly, gto a stereoscopic video display device and a stereoscopic video display method.

### BACKGROUND

Nowadays, two-dimensional images do not meet the growing demand for video and audio entertainment. Improvements in the art are preferred.

### BRIEF DESCRIPTION OF THE DRAWINGS

Implementations of the present technology will now be described, by way of example only, with reference to the attached figures.

FIG. 1 is a block diagram of an exemplary embodiment of a stereoscopic video display device of the present disclosure.

FIG. 2 is a block diagram of a stereoscopic video display system of the stereoscopic video display device of FIG. 1.

FIG. 3 is similar to FIG. 2, but another exemplary embodiment of a stereoscopic video display system.

FIG. 4 is a diagram of an operation interface displayed by the stereoscopic video display system of FIG. 3.

FIG. 5 is a diagram showing a selecting sub-interface displayed when a display button of the operation interface of FIG. 4 is clicked.

FIG. 6 is a diagram showing an uploading sub-interface displayed when an uploading button of the operation interface of FIG. 4 is clicked.

FIG. 7 is a diagram showing a transmitting sub-interface displayed when a transmitting button of the operation interface of FIG. 4 is clicked.

FIG. 8 is a flowchart of an exemplary embodiment of a stereoscopic video display method.

FIG. 9 is another flowchart of an exemplary embodiment of a stereoscopic video display method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In general, the word “module,” as used hereinafter, refers to logic embodied in hardware or firmware, or to a collection of software instructions, written in a programming language, such as, for example, JAVA, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

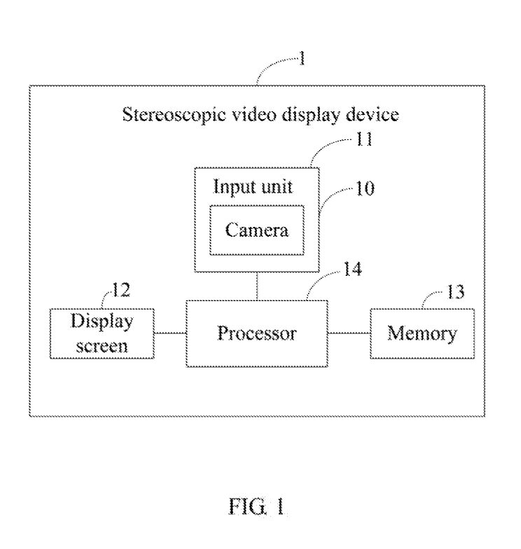

FIG. 1 illustrates an exemplary embodiment of a stereoscopic video display device 1. The device 1 can be a smart phone, a tablet computer, or a personal digital assistant. The device 1 comprises an input unit 11, a display screen 12, a memory 13, and at least one processor 14. The input unit 11 is for a user to input a video display operation for displaying a stereoscopic video. In one exemplary embodiment, the input unit 11 can be a camera 10. The video display operation can be scanning a QR code associated with the stereoscopic video through the camera 10.

The memory 13 can be an internal storage system of the device 1 such as a flash memory, a random access memory (RAM) for temporary storage of information, and/or a read-only memory (ROM) for permanent storage of information. The memory 13 can also be an external storage system, such as a hard disk, a storage card, or a data storage medium. The memory 13 further stores a stereoscopic video display system 100. The processor 14 can be a central processing unit (CPU), a microprocessor, or other data processor chip that performs functions of the system 100.

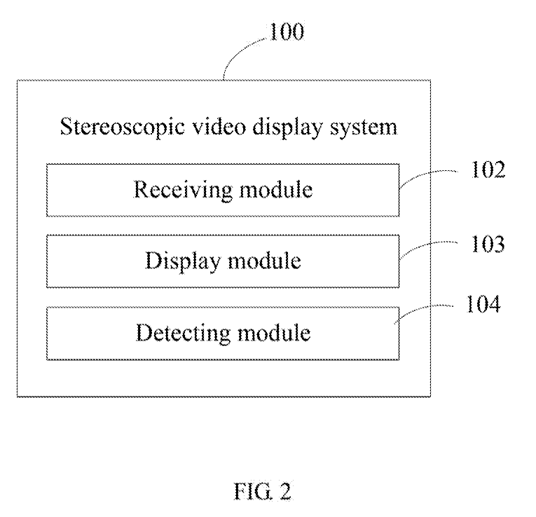

Referring to FIG. 2, the system 100 comprises a number of modules, which are a collection of software instructions which can be executed by the processor 14 to perform the function of the system 100. FIG. 2 is a block diagram of an exemplary embodiment of the system 100. The system 100 comprises a receiving module 102 and a display module 103.

The receiving module 102 receives the video display operation for displaying the stereoscopic video, which is input through the input unit 11.

The display module 103 displays the stereoscopic video on the display screen 12 in response to the video display operation.

In at least one exemplary embodiment, the video display operation can be scanning the QR code associated with the stereoscopic video through the camera 10. For example, a physical storing address of the stereoscopic video is coded to generate a QR code, thereby associating the QR code with the stereoscopic video. When the video display operation is input by scanning the QR code through the camera 10, the receiving module 102 receives the video display operation, and obtains the stereoscopic video associated with the QR code. For example, the device 1 can communicate with a cloud server (not shown) which stores the stereoscopic video. The receiving module 102 analyzes the physical storage address according to the QR code, and obtains the stereoscopic video from the cloud server through the physical storage address.

In at least one exemplary embodiment, the stereoscopic video comprises characters, audios, and images appearing to be in three dimensions. The QR code can be printed on a name card. The stereoscopic video associated with the QR code comprises characters of the name and the title of the person, and videos of the person. In another exemplary embodiment, the QR code can be displayed on a website of a company. The user can access the website by a cell phone or a computer to obtain the QR code. The stereoscopic video associated with the QR code comprises characters of a base introduction of the company, and videos describing the products or the physical location of the company. Thus, the user can get to know the company by scanning the QR code on the website. In other exemplary embodiments, the QR code can be displayed on a product introduction. The stereoscopic video associated with the QR code comprises texts and videos describing the use method or the installation method of the product. Thus, the user can get to know the use method or the installation method of the product by scanning the QR code on the product introduction.

In this exemplary embodiment, the system 100 can further comprise a detecting module 104. The detecting module 104 detects whether the camera 10 scans the QR code when the display module 103 displays the stereoscopic video. When the camera 10 doesn't scan the QR code, the display module 103 stops displaying the stereoscopic video associated with the QR code.

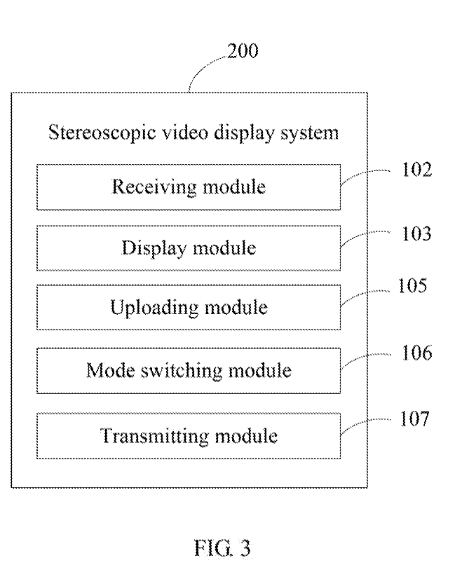

FIG. 3 is a block diagram of another exemplary embodiment of a system 200. The system 200 comprises a receiving module 102 and a display module 103.

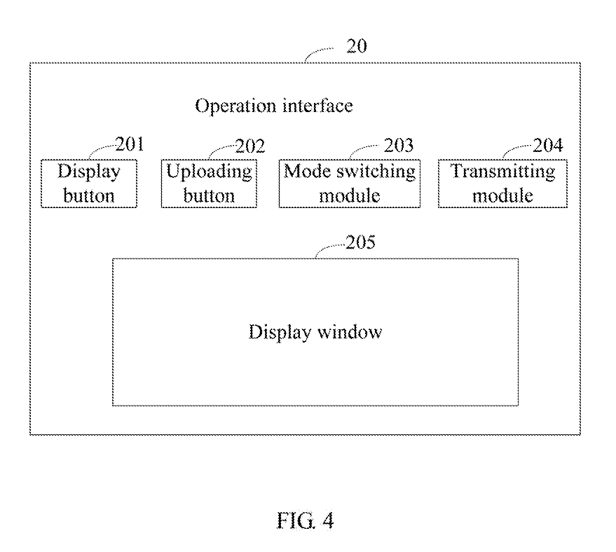

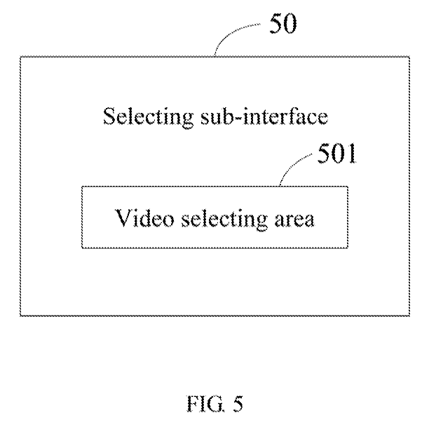

In this exemplary embodiment, the input unit 11 can be a touch panel for the user to input the video display operation when the user touches the touch panel. That is, the display screen 12 and the input unit 11 are integrated to form a touch-sensitive display screen. Note that the input unit 11 can also be a mouse, a keyboard, or any other input device for the user to input the video display operation. The stereoscopic video is stored in the memory 13. For example, the memory 13 can wirelessly communicate with a server (not shown) which stores the stereoscopic videos. The memory 13 can obtain the stereoscopic video from the server. The display module 103 displays an operation interface 20 on the display screen 12. Referring to FIG. 4, the operation interface 20 comprises a display button 201 and a display window 205. The user can click the display button 201 of the operation interface 20 to input the video display operation. The receiving module 102 receives the video display operation input through the display button 201. The display module 103 displays the stereoscopic video on the display window 205 in response to the video display operation. In this exemplary embodiment, the display module 103 displays a sub-interface offering selections (namely, selecting sub-interface 50, shown in FIG. 5) on the display screen 12 in response to the video display operation. The selecting sub-interface 50 comprises a video selecting area 501. The video selecting area 501 is for a user to select a stereoscopic video to be displayed. When a stereoscopic video is selected through the video selecting area 501, the display module 103 displays the selected stereoscopic video on the display window 205.

In this exemplary embodiment, the display module 103 further displays a QR code (not shown) on the operation interface 50. The QR code displayed on the operation interface 50 can be scanned by other devices 1 which can display the stereoscopic video associated with the QR code.

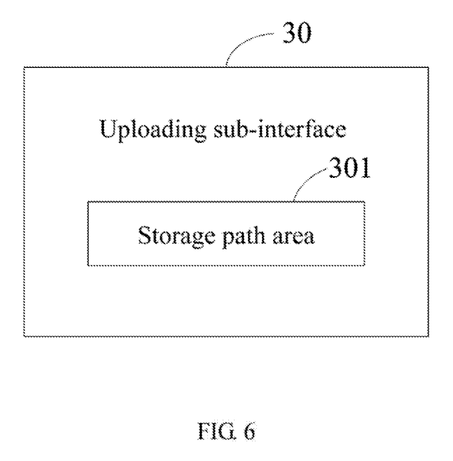

In this exemplary embodiment, the system 200 further comprises an uploading module 105. The operation interface 20 further comprises an uploading button 202. The uploading module 105 displays an uploading sub-interface 30 when the uploading button 202 is clicked. Referring to FIG. 6, the uploading sub-interface 30 comprises a storage path area 301. The storage path area 301 is for the user to select a stereoscopic video to be uploaded in a storage path of the stereoscopic video display device 1. When a stereoscopic video is selected through the storage path area 301, the uploading module 102 receives and stores the selected stereoscopic video. For example, when the display window 205 displays a webpage (a social webpage or a recruiting website), the user can click the uploading sub-interface 30, and select a stereoscopic video to be uploaded through the storage path area 301. Then, the uploading module 102 receives and stores the selected stereoscopic video.

In this exemplary embodiment, the system 200 further comprises a mode switching module 106. The operation interface 20 further comprises a mode switching button 203. The mode switching module 106 changes the display mode of the stereoscopic video when the mode switching button 203 is clicked. For example, the mode switching module 106 changes the display mode of the characters of the stereoscopic video. Specifically, the mode switching module 106 switches the characters of the stereoscopic video from a flowing display mode to a surrounding display mode.

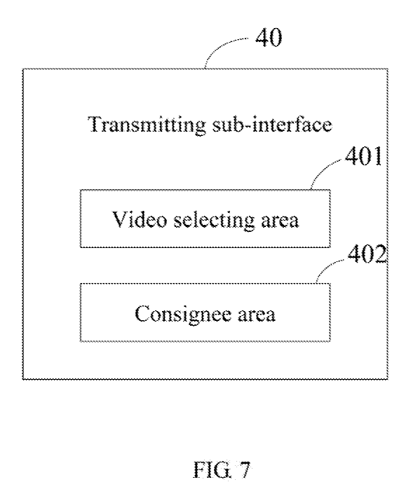

In this exemplary embodiment, the system 200 further comprises a transmitting module 107. The operation interface 20 further comprises a transmitting button 204. The transmitting interface 107 displays a transmitting sub-interface 40 when the transmitting button 204 is clicked. Referring to FIG. 7, the transmitting sub-interface 40 comprises a video selecting area 401 and a consignee area 402. The video selecting area 401 is for the user to select a stereoscopic video to be transmitted. The consignee area 402 is for the user to input the address of consignee. In at least one exemplary embodiment, the address of consignee can be an email address. When a stereoscopic video is selected through the stereoscopic video selection area 401 and the address of consignee is input through the consignee area 402, the transmitting module 107 transmits the selected stereoscopic video to the address of consignee.

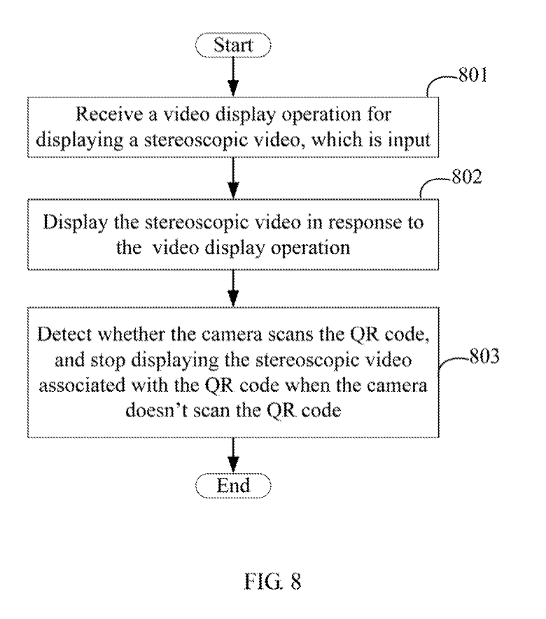

FIG. 8 illustrates an exemplary embodiment of a stereoscopic video display method. The method is provided by way of example, as there are a variety of ways to carry out the method. The method described below can be carried out using the configurations illustrated in FIG. 2, for example, and various elements of these figures are referenced in explaining example method. Each block shown in FIG. 8 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 801.

At block 801, the receiving module 102 receives a video display operation for displaying the stereoscopic video, which is input by scanning the QR code associated with the stereoscopic video through the camera 10, and obtains the stereoscopic video associated with the QR code.

For example, a physical storing address of the stereoscopic video is coded to generate the QR code, thereby associating the QR code with the stereoscopic video.

The device 1 can communicate with a cloud server (not shown) which stores the stereoscopic video. The receiving module 102 analyzes the physical storage address according to the QR code, and obtains the stereoscopic video from the cloud server through the physical storage address.

At block 802, the display module 103 displays the stereoscopic video on the display screen 12 in response to the video display operation.

In at least one exemplary embodiment, the stereoscopic video comprises characters, audios, and images appearing to be images in three dimensions. The QR code can be printed on a name card. The stereoscopic video associated with the QR code comprises characters of the name and the title of the person, and videos of the person. In another exemplary embodiment, the QR code can be displayed on a website of a company. The user can access the web site by a cell phone or a computer to obtain the QR code. The stereoscopic video associated with the QR code comprises characters of a base introduction of the company, and videos describing the products or the physical location of the company. Thus, the user can get to know the company by scanning the QR code on the website. In other exemplary embodiments, the QR code can be displayed on a product introduction. The stereoscopic video associated with the QR code comprises texts and videos describing the use method or the installation method of the product. Thus, the user can get to know the use method or the installation method of the product by scanning the QR code on the product introduction.

At block 803, the detecting module 104 detects whether the camera 10 scans the QR code when the display module 103 displays the stereoscopic video, and the display module 103 stops displaying the stereoscopic video associated with the QR code when the camera 10 doesn't scan the QR code.

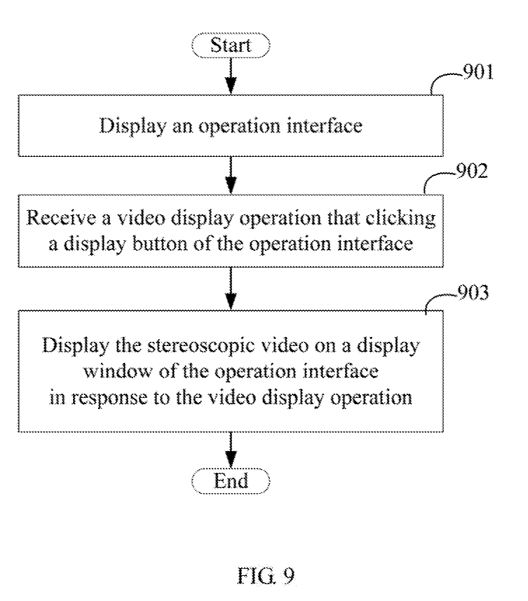

FIG. 9 illustrates another exemplary embodiment of a stereoscopic video display method. The method is provided by way of example, as there are a variety of ways to carry out the method. The method described below can be carried out using the configurations illustrated in FIG. 3, for example, and various elements of these figures are referenced in explaining example method. Each block shown in FIG. 9 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 901.

At block 901, the display module 103 displays an operation interface comprising a display button 201 and a display window 205.

At block 902, the receiving module 102 receives a video display operation of clicking the display button 201 of the operation interface 20.

At block 903, the display module 103 displays the stereoscopic video on the display window 205 in response to the video display operation.

In this exemplary embodiment, the display module 103 displays a sub-interface which offers selections (namely, selecting sub-interface 50, shown in FIG. 4) on the display screen 12 in response to the video display operation. The selecting sub-interface 50 comprises a video selecting area 501. The video selecting area 501 is for a user to select a stereoscopic video to be displayed. When a stereoscopic video is selected through the video selecting area 501, the display module 103 displays the selected stereoscopic video on the display window 205.

In this exemplary embodiment, the display module 103 further displays a QR code (not shown) on the operation interface 50. The QR code displayed on the operation interface 50 can be scanned by other devices 1 which can display the stereoscopic video associated with the QR code.

In this exemplary embodiment, the operation interface 20 further comprises an uploading button 202. The uploading module 105 displays an uploading sub-interface 30 when the uploading button 202 is clicked. The uploading sub-interface 30 comprises a storage path area 301. The storage path area 301 is for the user to select a stereoscopic video to be uploaded in a storage path of the stereoscopic video display device 1. The uploading module 102 receives and stores a stereoscopic video which is selected through the storage path area 301.

In this exemplary embodiment, the operation interface 20 further comprises a switching button 203. The mode switching module 106 changes the display mode of the stereoscopic video when the mode switching button 203 is clicked.

For example, the mode switching module 106 can change the display mode of the characters of the stereoscopic video. Specifically, the mode switching module 106 switches the characters of the stereoscopic video from a flowing display mode to a surrounding display mode.

In this exemplary embodiment, the operation interface 20 further comprises a transmitting button 204. The transmitting interface 108 displays a transmitting sub-interface 40 when the transmitting button 204 is clicked. The transmitting sub-interface 40 comprises a video selecting area 401 and a consignee area 402. The video selecting area 401 is for the user to select a stereoscopic video to be transmitted. The consignee area 402 is for the user to input the address of consignee. In at least one exemplary embodiment, the address of consignee can be the email address. The transmitting module 108 transmits a stereoscopic video selected through the stereoscopic video selection area 401, to an address of consignee input through the consignee area 402.

Even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A stereoscopic video display device comprising:
an input unit;
a display screen;
at least one processor; and
a memory coupled to the at least one processor and storing one or more programs, wherein when executed by the at least one processor, the one or more programs cause the at least one processor to:
receive a video display operation for displaying a stereoscopic video, which is input through the input unit; and
display the stereoscopic video on the display screen in response to the video display operation.

2. The stereoscopic video display device of claim 1, wherein the input unit comprises a camera, the one or more programs further cause the at least one processor to:
receive the video display operation input by scanning QR code associated with the stereoscopic video through the camera;
obtain the stereoscopic video associated with the QR code; and
display the obtained stereoscopic video on the display screen in response to the video display operation.

3. The stereoscopic video display device of claim 2, wherein a physical storing address of the stereoscopic video is coded to generate the QR code, thereby associating the QR code with the stereoscopic video.

4. The stereoscopic video display device of claim 2, wherein the one or more programs further cause the at least one processor to:
detect whether the camera scans the QR code when the display module displays the stereoscopic video; and
stop displaying the stereoscopic video associated with the QR code when the camera doesn't scan the QR code.

5. The stereoscopic video display device of claim 1, wherein the one or more programs further cause the at least one processor to:
display an operation interface on the display screen, the operation interface comprising a display button and a display window;
receive the video display operation of clicking the display button of the operation interface; and
display the stereoscopic video on the display window in response to the video display operation.

6. The stereoscopic video display device of claim 5, wherein the operation interface further comprises an uploading button, the one or more programs further cause the at least one processor to:
display an uploading sub-interface for a user to select a stereoscopic video to be uploaded, when the uploading button is clicked; and
receive and store the selected stereoscopic video.

7. The stereoscopic video display device of claim 5, wherein the operation interface further comprises a mode switching button, the one or more programs further cause the at least one processor to:
change a display mode of the stereoscopic video when the mode switching button is clicked.

8. The stereoscopic video display device of claim 5, wherein the operation interface further comprises a transmitting button, the one or more programs further cause the at least one processor to:
display a transmitting sub-interface when the transmitting button is clicked;
transmit a stereoscopic video selected through the transmitting sub-interface, to an address of consignee input through the transmitting sub-interface.

9. A stereoscopic video display method comprising:
receiving a video display operation for displaying a stereoscopic video, which is input through an input unit; and
displaying the stereoscopic video on a display screen in response to the video display operation.

10. The stereoscopic video display method of claim 9, further comprising:
receiving the video display operation input by scanning QR code associated with the stereoscopic video through a camera of the input unit;
obtaining the stereoscopic video associated with the QR code; and
displaying the obtained stereoscopic video on the display screen in response to the video display operation.

11. The stereoscopic video display method of claim 10, wherein a physical storing address of the stereoscopic video is coded to generate the QR code, thereby associating the QR code with the stereoscopic video.

12. The stereoscopic video display method of claim 10, further comprising:
detecting whether the camera scans the QR code when the display module displays the stereoscopic video; and
stopping displaying the stereoscopic video associated with the QR code when the camera doesn't scan the QR code.

13. The stereoscopic video display method of claim 10, wherein further comprising:
displaying an operation interface on the display screen, the operation interface comprising a display button and a display window;
receiving the video display operation of clicking the display button of the operation interface; and
displaying the stereoscopic video on the display window in response to the video display operation.

14. The stereoscopic video display method of claim 13, wherein the operation interface further comprises an uploading button, the stereoscopic video display method further comprises:
displaying an uploading sub-interface for a user to select a stereoscopic video to be uploaded, when the uploading button is clicked; and
receiving and storing the selected stereoscopic video.

15. The stereoscopic video display method of claim 13, wherein the operation interface further comprises a mode switching button, the stereoscopic video display method further comprises:
changing a display mode of the stereoscopic video when the mode switching button is clicked.

16. The stereoscopic video display method of claim 13, wherein the operation interface further comprises a transmitting button, the stereoscopic video display method further comprises:
displaying a transmitting sub-interface when the transmitting button is clicked;
transmitting a stereoscopic video selected through the transmitting sub-interface, to an address of consignee input through the transmitting sub-interface.
